(19) United States
(12) Patent Application Publication
(10) Pub. No.: US 2018/0174574 A1
(43) Pub. Date: Jun. 21, 2018

(54) METHODS AND SYSTEMS FOR REDUCING FALSE ALARMS IN KEYWORD DETECTION

(71) Applicant: Knowles Electronics, LLC, Itasca, IL (US)

(72) Inventor: Jean Laroche, Santa Cruz, CA (US)

(73) Assignee: Knowles Electronics, LLC, Itasca, IL (US)

(21) Appl. No.: 15/844,948

(22) Filed: Dec. 18, 2017

Related U.S. Application Data
(60) Provisional application No. 62/435,958, filed on Dec. 19, 2016.

(51) Int. Cl. G10L 15/08; G10L 15/22; G10L 15/20

(52) U.S. Cl. CPC G10L 15/08; G10L 15/22; G10L 15/063; G10L 2015/088; G10L 15/20

(57) ABSTRACT

Systems and methods for reducing false alarms in keyword detection are provided. An example method includes detecting a keyword in an acoustic signal. The acoustic signal can represent at least one captured sound. The method also includes acquiring an estimate of speech activity for a portion of the acoustic signal preceding the keyword. In some embodiments, the estimate includes an average of a voice activity detection output over frames of the acoustic signal within the portion preceding the keyword. If the estimate is less than a threshold, the method can accept the keyword detection. If the estimate is larger than the threshold, the method proceeds to reject the keyword detection.

### CROSS-REFERENCE TO RELATED APPLICATIONS

This application claims the benefit of and priority to U.S. Provisional Application No. 62/435,958, filed Dec. 19, 2016, the entire contents of which are incorporated herein by reference.

### SUMMARY

A false alarm in voice wake up can occur when a keyword is detected in a middle of a sentence. Various embodiments of the present technology can reduce false alarms by determining whether the detected keyword is preceded by active speech. Information from voice activity detection processing can be used to determine an estimate of speech activity in a portion of acoustic signal before the keyword. In various embodiments, if the estimate of speech activity is above a threshold, the keyword is rejected, otherwise the keyword is accepted.

### BACKGROUND

Voice-controlled devices are used in various applications. For example, the device can be operable to transition from a low power (sleeping) mode to a higher power operational mode in response to a keyword spoken by a user, i.e., voice wakeup. Two failures associated with using voice to wake up a device are false rejects and false alarms. The false rejects occur when the voice wake up system fails to recognize an actual keyword spoken by the user. The false alarms (also known as false accepts) happen when the voice wake up system recognizes a keyword even though none was spoken.

False alarms are troublesome for multiple reasons. False alarms can cause a device to wake up and unnecessarily consume power. False alarms can also be disturbing or annoying to a user (for example, if they prompt the user to ask a question). False rejects are also very undesirable. Therefore, it is crucial to keep the false alarm rate as low as possible without increasing the false reject rate. Typically, reducing false alarms is achieved by raising a detection threshold, but this may result in increasing false reject errors. Thus, traditionally, there is a tradeoff between tolerating false alarms and tolerating false rejects.

### BRIEF DESCRIPTION OF DRAWINGS

FIG. 1 is a block diagram illustrating an example environment in which methods for reducing false alarms in voice wake up can be practiced, according to various example embodiments.

FIG. 2A is a block diagram illustrating an audio device, according to an example embodiment.

FIG. 2B is a block diagram illustrating an audio device, according to another example embodiment.

FIG. 3 is a block diagram showing a system for reducing false alarms in voice wake up, according to an example embodiment.

FIG. 4 is a plot of example output of voice activity detection.

FIG. 5 is a flow chart showing a method for reducing false alarms in keyword detection, according to an example embodiment.

### DETAILED DESCRIPTION

The technology disclosed herein relates to systems and methods for reducing false alarms in keyword detection. Embodiments of the present technology may be practiced with any audio devices operable to capture and process acoustic signals.

In various embodiments, audio devices can include smart microphones which combine microphone(s) and logic into a single packaged device. In some embodiments, the smart microphone may comprise a combination of a microelectromechanical system (MEMS) microphone and a low power processor (e.g. a digital signal processor (DSP)) that can perform some limited processing of acoustic signals from the MEMS microphone.

In some embodiments, the audio devices may be hand-held devices, such as smart phones or other mobile telephones, wired and/or wireless remote controls, notebook computers, tablet computers, phablets, smart watches, personal digital assistants, media players, and the like. In certain embodiments, the audio devices include a personal desktop computer, TV sets, car control and audio systems, smart thermostats, and so on. The audio devices may have radio frequency (RF) receivers, transmitters, and transceivers, wired and/or wireless telecommunications and/or networking devices, amplifiers, audio and/or video players, encoders, decoders, loudspeakers, inputs, outputs, storage devices, and user input devices.

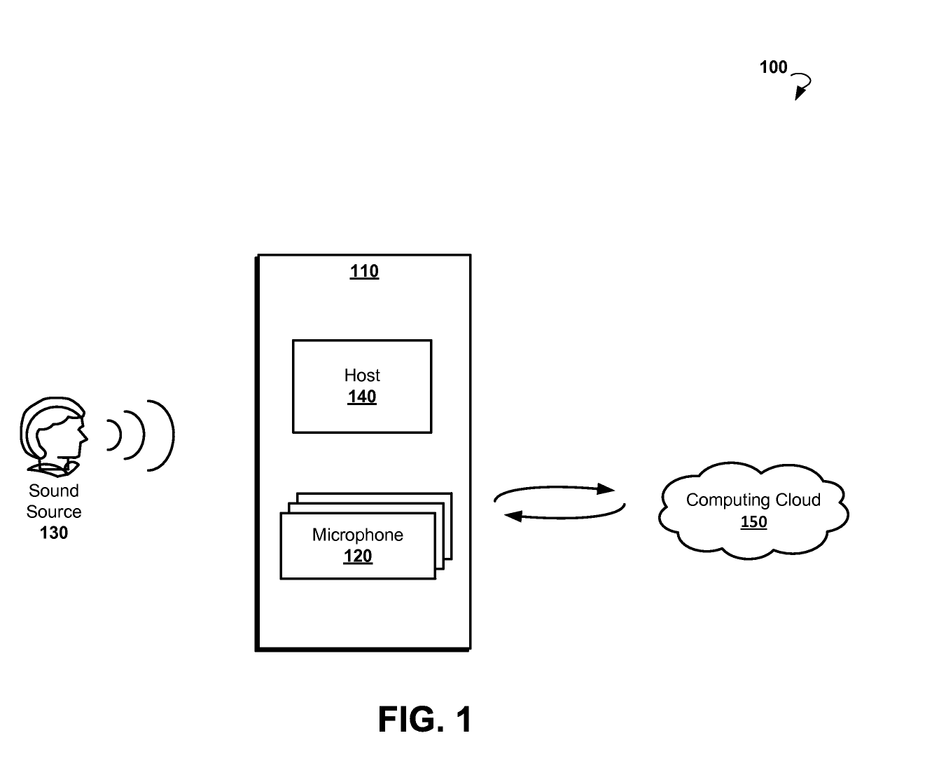

Referring now to FIG. 1, an example environment 100 is shown in which a method for reducing false alarms in voice wake up can be practiced. Example environment 100 includes at least an audio device 110 (also referred to as a listening device) which is operable at least to listen for and receive an acoustic signal via one or more acoustic sensors, e.g., microphones 120. Microphones 120 may include a MEMS sensor, a piezoelectric sensor or other acoustic sensor. The acoustic signal captured by the microphone(s) 120 in audio device 110 can include at least an acoustic sound 130, for example, speech of a person operating the audio device 110.

In some embodiments, the audio device 110 includes a host 140 that communicates with microphones 120. Host 140 can include one or more processors (e.g. x86 microprocessors, DSPs, etc.). In certain embodiments, microphones 120 and at least some components of host 140 are commonly disposed on an application-specific integrated circuit (ASIC) (e.g. a smart microphone). In embodiments, host 140 processes the received acoustic signal independently. In certain embodiments, the acoustic signal captured by the audio device 110 is transmitted to a further computing device for additional or other processing.

For example, in some embodiments, the audio device 110 is connected to a cloud-based computing resource 150 (also referred to as a computing cloud). In some embodiments, the computing cloud 150 includes one or more server farms/clusters comprising a collection of computer servers and is co-located with network switches and/or routers. The computing cloud 150 is operable to deliver one or more services over a network (e.g., the Internet, mobile phone (cell phone) network, and the like). The audio device 110 may be operable to send data such as, for example, a recorded audio signal, to a computing cloud, request computing services and receive back the results of the computation.

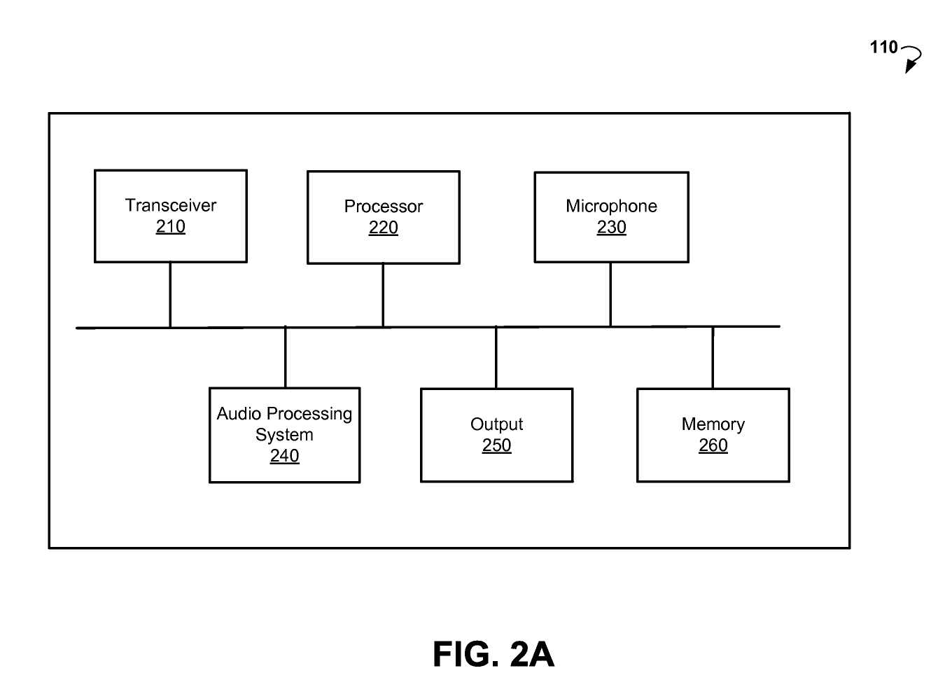

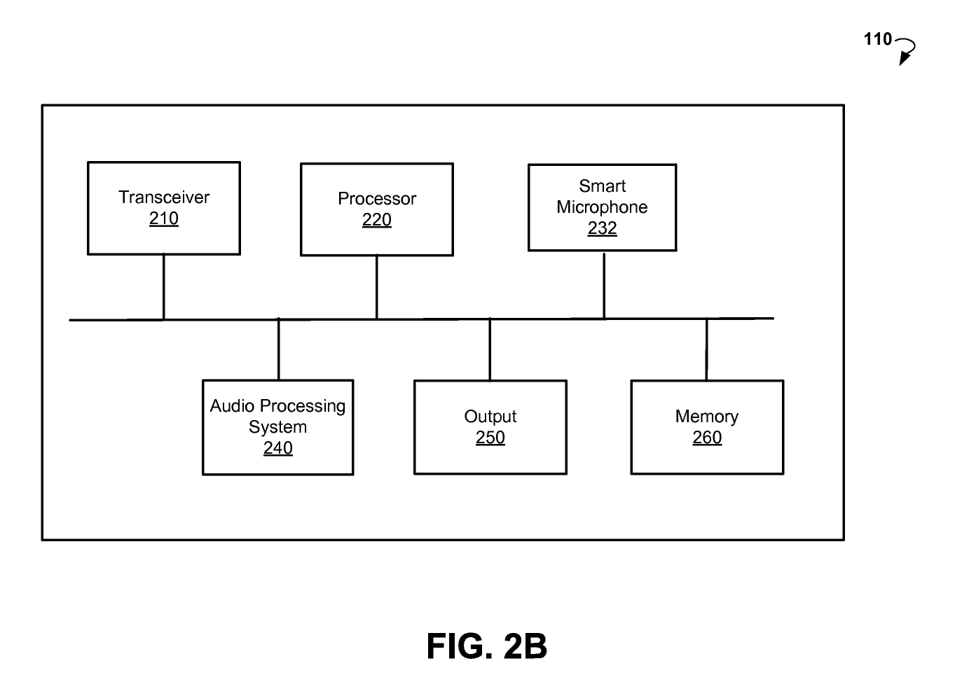

FIG. 2A is a block diagram illustrating an example audio device 110 suitable for practicing the present technology. The example audio device may include a transceiver 210, a processor 220, at least one microphone 230, a processor 240, an output block 250, and a memory 260. In other embodiments, the smart microphone 120 includes additional or different components to provide a particular operation or functionality. Similarly, the audio device 110 may comprise fewer components that perform similar or equivalent functions to those depicted in FIG. 2A.

In some embodiments, the transceiver 210 is configured to communicate with a network such as the Internet, Wide Area Network (WAN), Local Area Network (LAN), cellular network, and so forth, to receive and/or transmit audio data stream. The received audio data stream may be then forwarded to the audio processing system 240 and the output device 250.

The processor 220 may include hardware and software that implement the processing of audio data and various other operations depending on a type of the audio device 110 (e.g., communication device and computer). The memory 260 (e.g., non-transitory computer readable storage medium) may store, at least in part, instructions and data for execution by processor 220.

The microphone 230 may include various types of microphones, such as a MEMS microphone, a piezoelectric microphone or other acoustic sensor.

The audio processing system 240 may include hardware and software that implement the processing of acoustic signal(s). For example, the audio processing system 240 can be further configured to receive acoustic signals from an acoustic source via microphone 120 (which may be one or more microphones or acoustic sensors) and process the acoustic signals. After reception by the microphone(s) 120, the acoustic signals may be converted into electric signals by an analog-to-digital converter.

The output device 250 includes any device which provides an audio output to a listener (e.g., the acoustic source). For example, the output device 250 may comprise a loudspeaker, a class-D output, an earpiece of a headset, or a handset on the audio device 110.

FIG. 2B is a block diagram illustrating another example audio device 110 suitable for practicing the present technology. This example audio device may include similar components as shown in FIG. 2A and described above. However, differently from the example in FIG. 2A, in this example, audio device 110 includes a smart microphone 232. Smart microphone 232 includes a microphone such as a MEMS microphone, a piezoelectric microphone or other acoustic sensor. Smart microphone 232 further includes its own processor such as a low power digital signal processor (DSP). This processor and perhaps other circuitry may be implemented in an application specific integrated circuit (ASIC) that is packaged together with the microphone.

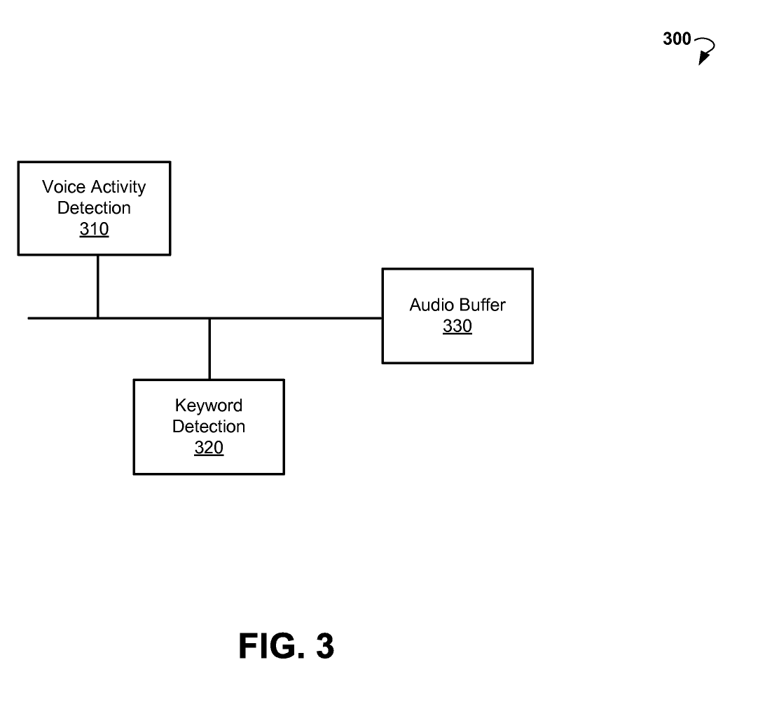

FIG. 3 is a block diagram showing components of a system 300 for processing an acoustic signal, according to an example embodiment. The example system 300 includes at least a voice activity detector (VAD) 310 and a keyword detector (KD) 320. As shown, the VAD 310 and the KD 320 are operable to process an acoustic signal stored in audio buffer 330. In some embodiments, the acoustic signal is received by microphone 230 and buffered in memory 260 (shown in FIG. 2A). In other embodiments, the acoustic signal is received by smart microphone 232 (shown in FIG. 2B) and buffered in an on-chip memory.

In certain embodiments, VAD 310 and the KD 320 are implemented as instructions stored in memory 260 of audio device 110 and executed by processor 220 (shown in FIG. 2A). In other embodiments, some of the functionality of the VAD 310 and the KD 320 are implemented by smart microphone 232 (shown in FIG. 2B) and other of the functionality of the VAD 310 and the KD 320 are implemented by instructions executed by processor 220 and/or audio processing system 240. In certain embodiments, one or both of the VAD 310 and the KD 320 are integrated into the audio processing system 240. In other embodiments, one or both of the VAD 310 or the KD 320 are implemented as separate firmware microchips installed in audio device 110. For example, VAD 310 can be incorporated in audio device 110 and KD 320 can be implemented in a separate module in audio device 110.

According to various embodiments, the VAD 310 is operable to receive an acoustic signal and analyze the received acoustic signal to determine whether the acoustic signal contains speech. In some embodiments, the VAD 310 is operable to analyze the acoustic signal using a combination of a fast Fourier transform (FFT)-based statistical approach (statistical VAD) and efficient background noise tracking.

In some embodiments, the audio device 110 is configured to operate in a listen mode. In operation, the listen mode consumes low power (for example, less than 5 mW). In some embodiments, the listen mode continues, for example, until an acoustic signal is received. One or more stages of VAD 310 can be used to be used to determine when an acoustic signal is received. The received acoustic signal can be stored or buffered in a buffer 330 before or after the one or more stages of VAD 310 are used based on power constraints. In various embodiments, the listen mode continues, for example, until the acoustic signal and one or more other inputs are received. The other inputs may include, for example, a contact with a touch screen in a random or predefined manner, moving the mobile device from a state of rest in a random or predefined manner, pressing a button, and the like.

Some embodiments of audio device 110 may include a wakeup mode. In response, for example, to the acoustic signal and other inputs, the audio device 110 can enter the wakeup mode. In operation, the wake up mode can determine whether the (optionally recorded or buffered) acoustic signal includes speech. One or more stages of VAD 310 can be used in the wakeup mode. The speech, for example, can include a keyword selected by a user.

The VAD 310 can be operable to characterize (label) frames within the acoustic signal as a speech (1) or as a silence (0). In some embodiments, output of the VAD 310 for a pre-determined time period is stored, for example, in memory 260, to be available to other applications and elements, for example, KD 320.

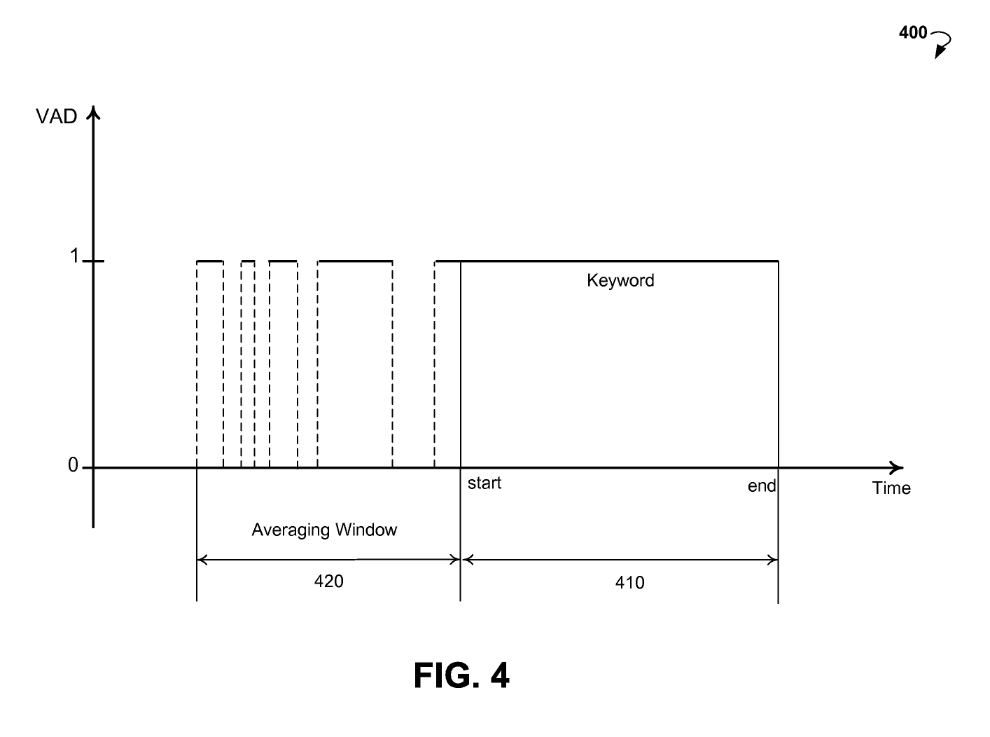

FIG. 4 is a plot 400 of example output of the VAD 310. In the example of FIG. 4, frames of a captured acoustic signal containing voice are labeled as 1 and frames containing no voice (that is either silence or a noise not related to speech) are labeled as 0. Time period 410 includes frames of acoustic signal corresponding to a keyword. Time period 420 includes frames preceding the keyword.

In some embodiments, the audio device 110 is activated in response to certain recognized speech such as keywords and the like. In certain embodiments, the audio device 110 is controlled in response to keywords. For example, the audio device 110 may start one or more applications in response to detection of keywords. The keywords and other voice commands may be selected by the user or pre-programmed into the audio device 110. According to various embodiments, the KD 320 is operable to receive the acoustic signal and analyze the received acoustic signal to determine whether the acoustic signal contains a keyword used to activate or control the audio device 110.

In some embodiments, the audio device 110 is trained with stock and/or user-defined keyword(s). For example, a certain user speaks the keyword at least once. Based at least in part on the spoken keyword sample(s) received from the certain user by one or more microphones 120 of the audio device 110, data representing the keyword spoken by the certain user can be stored. Training can be performed on the audio device 110, cloud-based computing resource(s) 150, or combinations thereof. Audio device 110 can allow a user to specify his/her own user-defined keyword, for example, by saying it four times in a row, so that the device can “learn” the keyword (training the audio device). Thereafter, the new keyword can then be used to wake-up the device and/or unlock the device.

In various embodiments, the audio device 110 wakes up or an application of audio device 110 is activated after determining that the keyword (assigned for the wake up or the activation) is not spoken as part of a sentence. That is, the keyword is preceded by a certain duration of silence or noise (but not speech). To that end, the VAD 310 may be used to inform the KD 320 of speech activity before the start of the keyword. The KD 320 can then estimate the amount of speech present in past frames of the acoustic signal. Some VAD algorithms provide a continuous (floating point) output value (for example between 0 and 1, 0 indicating no speech activity, 1 indicating speech activity and values in between indicating intermediate speech activity likelihood). Other VAD algorithms output a binary value (0 or 1). Both types can be used in the present embodiments, and both the continuous or binary values can be averaged over a length of time, as described below.

In some embodiments, after an initial successful keyword detection by the KD 320, KD 320 averages speech activity in past frames (the output of VAD 310) over a window that starts at a pre-determined time (a few hundreds of milliseconds, e.g., 300 milliseconds) before the start of the keyword, and ends at the start of the keyword. In example of FIG. 4 the window is denoted as time period 420. If the average of the VAD output is above a pre-determined threshold, the initial keyword is rejected by KD 320, otherwise the keyword is accepted by KD 320. Once accepted, the detected keyword, or an indication thereof, can be used to activate or control the audio device 110. It should be noted that using a pre-determined threshold is not necessary in all embodiments. In some embodiments, the threshold may be varied, either automatically or by user selection, for example.

In order not to impact true detections, the tuning of the VAD 310 should be conservative. The VAD system should only flag speech when it's quite confident that speech is present. For example, in very noisy conditions, such as babble noise at 0 dB, the VAD should be tuned to avoid flagging speech activity if the target speaker is not speaking, because this would affect keyword detection negatively (a keyword spoken by the target speaker could nonetheless be rejected because the VAD may have—falsely—detected speech activity just before the start of the keyword). Note that it's not necessary to store the audio signal itself to determine the speech activity just before the start of the keyword. A better solution may consist of storing the VAD output values at each frame processed into a small memory array and compute the average after the keyword is initially detected. The threshold is selected as the lowest value that yields a degradation in true detection less than, for example, 0.5%. This can be done by running extensive tests on a large database of spoken keywords in various noise environments, with various threshold values, and selecting the lowest threshold value for which the true detections are within 0.5% of true detections obtained with an infinite threshold (i.e. with the present invention disabled). The selected threshold can then be programmed or configured into an electronic device containing the VAD and KD of the present embodiments for use during operation of the electronic device.

Embodiments of the present disclosure utilize the fact that many false alarms occur in the middle of sentences and are caused by words that resemble the keyword. Technology described herein provides the solution to prevent or substantially reduce such false alarms. Embodiments of the present disclosure also take into account the fact that users who attempt to wake up an audio device may say the keyword in isolation, i.e., the keyword is preceded by some silence or noise, but not speech. The present technology allows accepting such isolated keywords. The present technology provides reduction in false alarms without incurring additional false rejects. In the regard, tests have been performed that show that the disclosed technology allows reducing false alarms by 50% with a very negligible increase in false rejects.

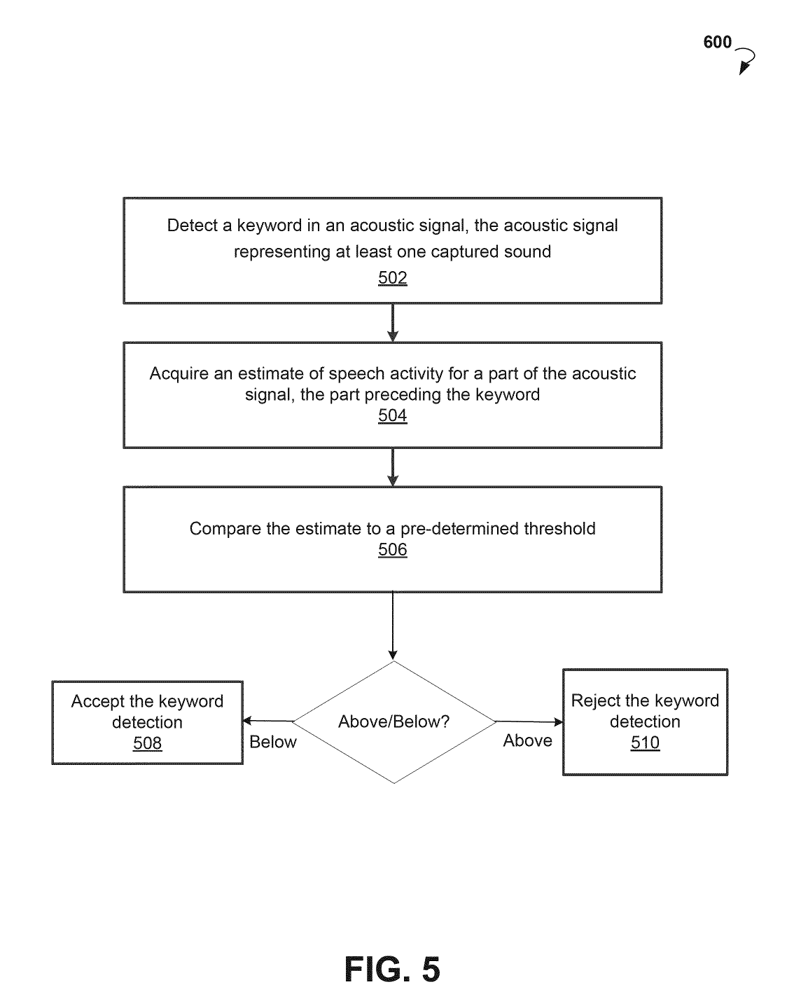

FIG. 5 is a flow chart showing steps of a method 500 for reducing false alarms in voice wake up, according to an example embodiment. The method 500 can be implemented in environment 100 using audio device 110. The method 500 may commence in block 502 with detecting a keyword in an acoustic signal. The acoustic signal can represent at least one captured sound.

In block 504, the method 500 can proceed with acquiring an estimate of speech activity for a portion of the acoustic signal preceding the keyword. In various embodiments, the estimate includes an average of the VAD output for frames of the acoustic signal within the portion. As described above, in embodiments the estimate of the speech presence in past frames (output of VAD 310) is averaged over a window that starts at a pre-determined time (a few hundreds of milliseconds, e.g., 300 milliseconds) before the start of the keyword, and ends at the start of the keyword. It should be appreciated that in embodiments where the VAD output is a value between 0 and 1, or is either 0 or 1, the estimate will be a number between 0 and 1.

In block 506, the method 500 can proceed with comparing the estimate to a pre-determined threshold. In block 508, if the estimate is less than the pre-determined threshold, the keyword detection if accepted. If, on the other hand, the estimate is larger than the pre-determined threshold, the method 500 can proceed, in block 510, with rejecting the keyword detection.

As set forth above, the predetermined threshold can be obtained by running extensive offline tests on a large database of spoken keywords in various noise environments, with various threshold values, and selecting the lowest threshold value for which the true detections are within 0.5% of true detections obtained with an infinite threshold (i.e. with the present invention disabled). As further set forth above, using a pre-determined threshold is not necessary in all embodiments. In some embodiments, the threshold may be varied, either automatically or by user selection, for example.

The present technology is described above with reference to example embodiments. Therefore, other variations upon the example embodiments are intended to be covered by the present disclosure.

What is claimed is:

1. A method for reducing false alarms in keyword detection, the method comprising:
detecting a keyword in an acoustic signal, the acoustic signal representing at least one captured sound;
computing an estimate of speech activity for a portion of the acoustic signal, the portion preceding the keyword;
comparing the estimate to a threshold;
if the estimate is less than the threshold, accepting the keyword detection; and
if the estimate is larger than the threshold, rejecting the keyword detection.

2. The method of claim 1, wherein the estimate includes an average of speech activity in the acoustic signal within the portion preceding the keyword.

3. The method of claim 2, wherein the average is computed using voice activity detection (VAD) output.

4. The method of claim 3, wherein the VAD output includes respective values related to speech and silence in the acoustic signal.

5. The method of claim 2, wherein the portion is a plurality of frames of the acoustic signal.

6. The method of claim 1, wherein the threshold is pre-determined.

7. The method of claim 1, further comprising computing the threshold based on a target degradation of true detection.

8. The method of claim 7, wherein computing the threshold includes:
running tests on a plurality of spoken keywords with a plurality of threshold values;
determining a degradation of true detection for each of the plurality of threshold values; and
selecting the lowest of the plurality of threshold values that yields the degradation of true detection less than the target degradation as the threshold.

9. The method of claim 8, wherein the degradation is determined with respect to true detections obtained with an infinite threshold.

10. A method for operating a device, the method comprising:
detecting a keyword in an acoustic signal, the acoustic signal representing at least one captured sound;
computing an estimate of speech activity for a portion of the acoustic signal, the portion preceding the keyword;
comparing the estimate to a threshold;
if the estimate is less than the threshold, accepting the keyword detection and performing an action for the device based on the detected keyword; and
if the estimate is larger than the threshold, rejecting the keyword detection.

11. The method of claim 10, wherein the estimate includes an average of speech activity in the acoustic signal within the portion preceding the keyword.

12. The method of claim 11, wherein the average is computed using voice activity detection (VAD) output.

13. The method of claim 12, wherein the VAD output includes respective values related to speech and silence in the acoustic signal.

14. The method of claim 11, wherein the portion is a plurality of frames of the acoustic signal.

15. The method of claim 10, wherein performing the action includes starting one or more applications in the device.

16. The method of claim 15, further comprising determining the one or more applications to start based on the keyword.

17. The method of claim 10, wherein performing the action includes waking up the device or unlocking the device.

18. A device comprising:
a voice activity detector for producing an output in accordance with speech activity in an acoustic signal, the acoustic signal representing at least one captured sound;
a keyword detector for detecting a keyword in the acoustic signal, the keyword detector being further configured to:
compute an estimate of speech activity for a portion of the acoustic signal based on the output of the voice activity detector, the portion preceding the keyword;
compare the estimate to a threshold;
if the estimate is less than the threshold, accept the keyword detection; and
if the estimate is larger than the threshold, rejecting the keyword detection.

19. The device of claim 18, wherein the estimate includes an average of speech activity in the acoustic signal within the portion preceding the keyword.

20. The device of claim 18, wherein the output of the voice activity detector includes respective values related to speech and silence in the acoustic signal.
